(19) United States
(12) Patent Application Publication
(10) Pub. No.: US 2003/0007008 A1
(43) Pub. Date: Jan. 9, 2003

(54) Computer controlled display system with scroll bar means for indicating the type of data being scrolled at particular locations in a displayed document

(75) Inventors: Gerald Francis McBrearty, Austin, TX (US); Shawn Patrick Mullen, Buda, TX (US); Johnny Meng-Han Shieh, Austin, TX (US)

Correspondence Address: Volel Emile, International Business Machines Corporatin, Intellectual Property Law Department, Internal Zip 4054, 11400 Burnet Road, Austin, TX, 78758, US

(73) Assignee: International Business Machines Corporation, Armonk, NY (US)

(21) Appl. No.: 09/899,455

(22) Filed: Jul. 5, 2001

(51) Int. Cl. G09G 5/00

(52) U.S. Cl. 345/786; 345/764

(57) ABSTRACT

Scrolling through lengthy Web pages or other documents in search of particular data types or files is simplified. In a system for scrolling a displayed document using a scroll bar for indicating the position of the displayed data in the direction being scrolled, there is provided an implementation for determining the type of the displayed data being scrolled at a position, in combination with an implementation responsive to this determination for indicating within said scroll bar the type of data being scrolled at said position. A color indicator has been found to provide very effective indication.

### TECHNICAL FIELD

The present invention relates to computer controlled display systems, and particularly to user interfaces in such systems for scrolling displayed documents containing data of different information types so as to facilitate a user accessing information of different types from the documents.

### BACKGROUND OF RELATED ART

For many years the data processing industries have been devoting great resources to making computer supported user interactive display technology systems and methods to provide interactive users with an interface environment that is easy to use. This has been a major task since the great expansion of computer users over the past decade has expanded computer use to less and less skilled and sophisticated users. This effort has been further driven by the rise of the Internet or World Wide Web (Web). The latter two terms are meant to be interchangeable are used as such throughout this application. In effect, there has been a technological revolution driven by the convergence of the data processing industry with the consumer electronics industry. This advance has been even further accelerated by the extensive consumer and business involvement in the Internet over the past five years. As a result of these changes, it seems as if virtually all aspects of human endeavor in the industrialized world requires human-computer interfaces. There is a need to make computer directed activities accessible to a substantial portion of the industrial world's population, which, up to a few years ago was computer-illiterate or, at best, computer indifferent. The population will, to a large part, have to become involved with computer interfaces and computer interfaces must, thus, continue to be simplified and made more user friendly.

This problem of simplification is particularly pronounced in the Web or Internet. Hypertext Markup Language (HTML), which has been the documentation language of the Internet or Web for years, offers direct links between pages and other documentation on the Web and a variety of related data sources that were, at first, text and then images, and now include media, i.e. “hypermedia”, which involves audio, video and all types of visual files. It was possible for the Web browser to spend literally hours going through document after document in search of hypermedia files of accompanying media events in often less than productive excursions through the Web. The obvious advantage of the Web is that a user has extensive access to such media events that he may access and use in his own presentations. The problem remains in locating them. A significant source of this problem is in the Web page, the basic document page of the Web. In the case of Web pages, we do not have the situation of a relatively small group of professional designers working out the human factors, rather, in the era of the Web, anyone and everyone can design a Web page. As a result, pages are frequently designed by developers without imaging or graphics layout skills. Media files may frequently be hard to recognize and locate in such pages. When we refer to Web pages, we are actually referring to Web documents that are often dozens of pages in length and often eclectically developed and organized. Most do not have adequate indices. Thus, the user has to scroll through a lengthy Web document that frequently contains ancillary distractions, such as advertising, to try to find the particular data of interest.

### SUMMARY OF THE PRESENT INVENTION

The present invention provides a solution that simplifies scrolling through lengthy Web or other documents in search of particular data types or files. In a system for scrolling a displayed document using a scroll bar for indicating the position of the displayed data in the direction being scrolled, there is provided means for determining the type of the displayed data being scrolled at said position, in combination with means responsive to said determining means for indicating within said scroll bar the type of data being scrolled at said position. A color indicator has been found to provide very effective indication.

While this invention may be used quite effectively on the Web for the above-described problems, it may also be a tool in locating predetermined types of data in scrolling through long word processed documents, such as legal briefs or technical and commercial reports.

In the HTML documents of the Web or in E-Mail, the invention is particularly useful in locating non-ascii text files, such as GIF or MIME data files, within the ascii text of the document. The scroll bar indicators of the present invention may even be used to focus the user's to embedded hyperlinks in such HTML documents.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing a user interactive workstation such as a Web receiving station on which received data may be converted into displayed Web pages;

FIG. 2 is a generalized diagrammatic view of a Web portion upon which the present invention may be implemented;

FIG. 3 is a diagrammatic view of a Web page displayed and scrolled at a receiving display station with a typical GIF image data file being indicated by a scroll bar indicator;

FIG. 4 is a diagrammatic view of a received E-mail document displayed and scrolled at a receiving display station with a MIME image data file being indicated by a scroll bar indicator;

FIG. 5 is an illustrative flowchart describing the setting up of the elements needed for the program for implementing scroll bar indicators to point to different data types in received Web documents; and

FIG. 6 is a flowchart of an illustrative run of the program set up in FIG. 5.

### DETAILED DESCRIPTION OF THE PREFERRED EMBODIMENT

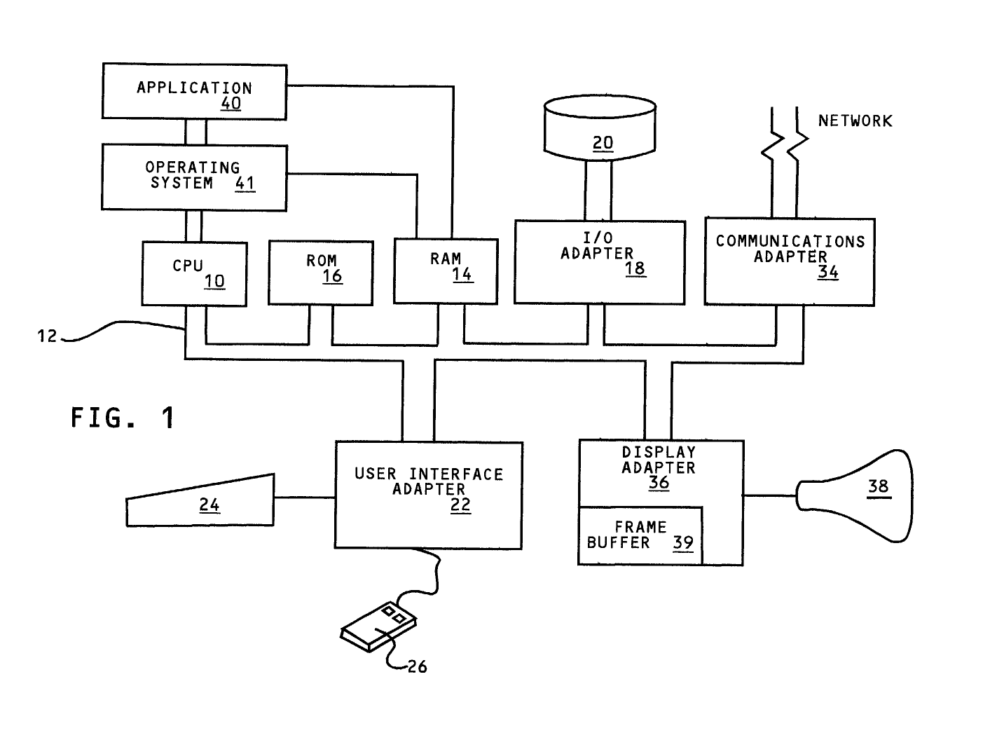

Referring to FIG. 1, a typical data processing terminal is shown that may function as a standalone computer controlled display unit for processing displayed documents or as a Web display station used for receiving Web pages. Such display units or Web stations may be used in the practice of the present invention for scrolling documents and indicating the data types being scrolled through indicators in the scroll bar.

A central processing unit (CPU) 10, such as one of the PC microprocessors or workstations, e.g. RISC System/6000™ (RS/6000) series available from International Business Machines Corporation (IBM), is provided and interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; Microsoft's Windows98™ or WindowsNT™, as well as UNIX and IBM's AIX operating systems. Application programs 40, controlled by the system, are moved into and out of the main memory Random Access Memory (RAM) 14. These programs include the programs of the present invention for providing an indicator within the scroll bar to indicate the type of data being scrolled. These programs will be subsequently described in combination with any conventional Web browser, such as the Netscape Navigator 3.0™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with other such systems over a Local Area Network (LAN) or a Wide Area Network (WAN), which includes, of course, the Web or Internet. I/O devices are also connected to system bus 12 via user interface adapter 22 and display adapter 36. Keyboard 24 and mouse 26 are all interconnected to bus 12 through user interface adapter 22.

It is through such input devices that the user may interactively relate to Web pages. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand, from a more general perspective, the various elements and methods which may be related to the present invention. Since the major aspect of the present invention is directed to Web pages transmitted over global networks, such as the Web or Internet, an understanding of networks and their operating principles would be helpful. We will not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999. Any data communication system that interconnects or links computer controlled systems with various sites defines a communications network. Of course, the Internet or Web is a global network of a heterogeneous mix of computer technologies and operating systems. Higher level objects are linked to the lower level objects in the hierarchy through a variety of network server computers.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly pp. 637-642, on HTML in the formation of Web pages.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers.

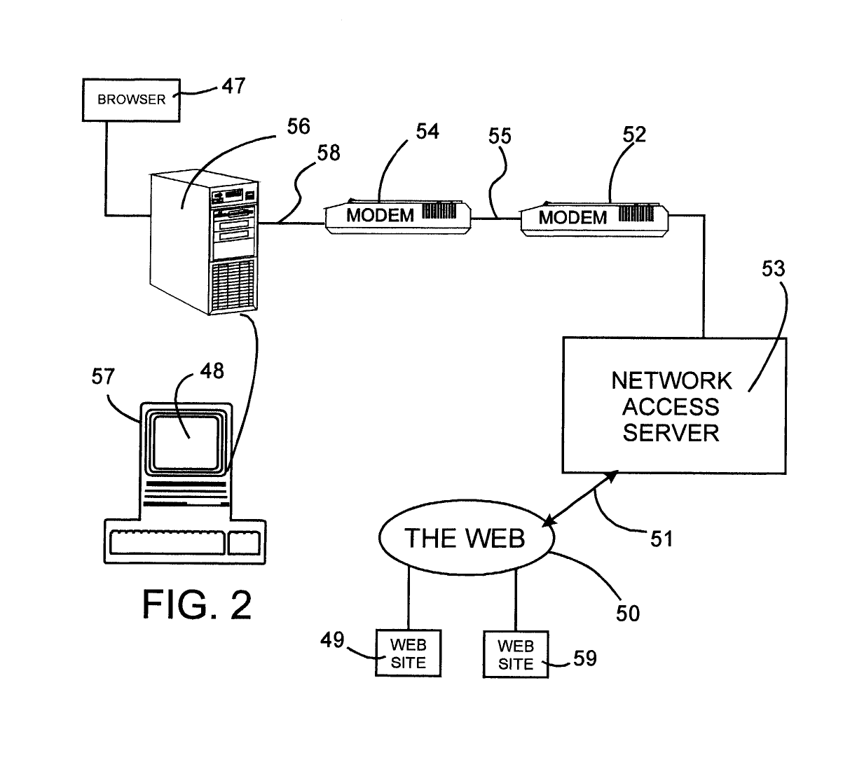

A generalized diagram of a portion of the Web, which the display 57 controlled by computer 56 used for Web page receiving during searching or browsing, is connected as shown in FIG. 2. Computer 56 display terminal 57 may be implemented by the computer system set up in FIG. 1 and connection 58 (FIG. 2) is the network connection shown in FIG. 1. For purposes of the present embodiment, computer 56 display 57 serves as a Web display station and has received displayed Web page 48 which is one of a sequence of Web pages.

Reference may be made to the above-mentioned Mastering the Internet, pp. 136-147, for typical connections between local display stations to the Web via network servers, any of which may be used to implement the system on which this invention is used. The system embodiment of FIG. 2 has a host dial-up connection. Such host dial-up connections have been in use for over 30 years through network access servers 53 which are linked 51 to the Web 50. The servers 53 may be maintained by a service provider to the client's display terminal 56, 57. The host's server 53 is accessed by the receiving or requesting terminal 56, 57 through a normal dial-up telephone linkage 58 via modem 54, telephone line 55 and modem 52. The HTML file representative of the Web page 48 has been downloaded to display terminal 57 through Web access server 53 via the telephone line linkages from server 53, which may have accessed them from the Internet 50 via linkage 51. The Web browser program 47 operates within the display terminals 57 to control the communication with the Web access server 53 to thereby download and display the accessed Web pages 56 on display terminal 57. The Web documents are accessed from Web site resources 49 and 59.

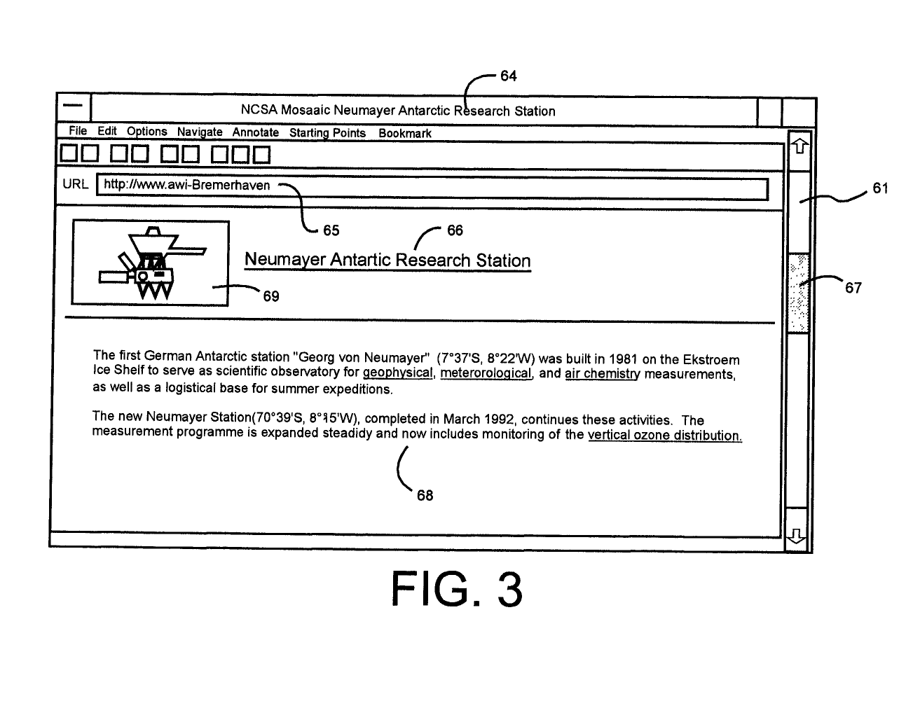

With this setup, the present invention, which will be subsequently described in greater detail with respect to FIGS. 3 through 6, may be carried out using Web browser program 47 in the case of scrolling through a Web page. In FIG. 3, there is shown a Web page 64 that originated from Web site 65 on the subject of Antarctic Research 66. Assume that the Web document is made up of a sequence of such Web pages. The page contains a video 69 of a moving ice tracking device which is provided by a GIF file while the rest of the portion of the page 64 shown is HTML text (ascii) 60. When the Web browser associated with the receiving station determines that the page being scrolled reaches video 69, the browser then determines if the non-ascii file 69 is a GIF file. The browser may then look up a color for GIF files in an appropriate table and may find, for example, red. Then, during the scrolling of Web page 64 for the extent that GIF image 69 is on the display screen, red indicator bar 67 will appear within scroll bar 61.

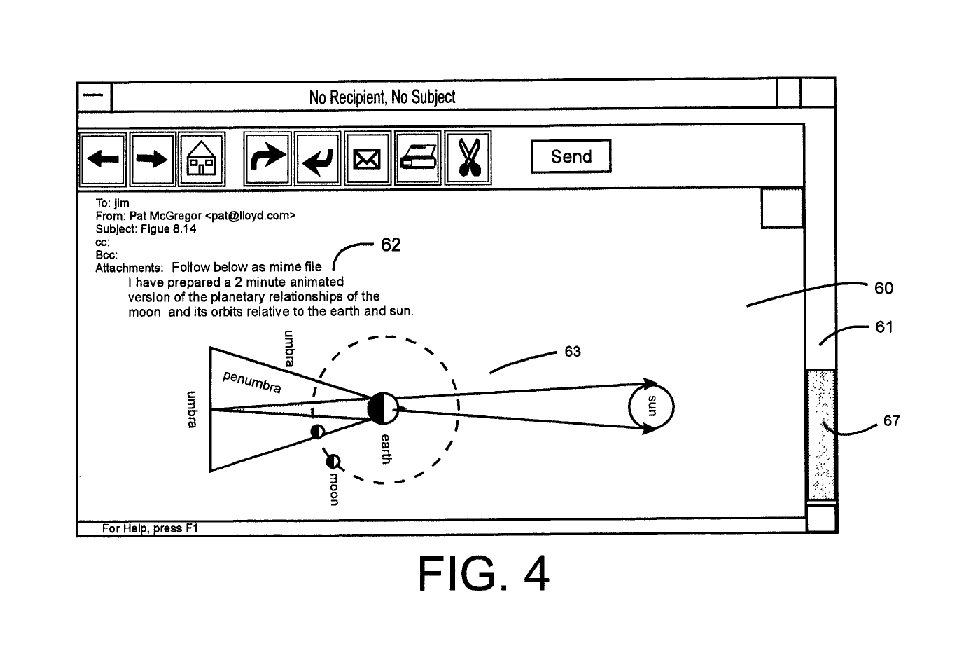

Similarly, FIG. 4 is an illustration of an animated MIME image 63 within an e-mail 60 that is received over the Web. E-mail document 60 has been reduced in extensiveness for purposes of illustration. Of course, the E-mail may be a much more extensive document of many pages with different attachments. A MIME attachment is described in the above-mentioned text, Internet: The Complete Reference, Millennium Edition, Margaret Young et al., at page 810. It is described as a Multimedia Internet Mail Extension that may be used in either Web documents or E-mail. Dependent upon the user's needs, the browser controlling the scrolling of FIG. 4 may be set up to distinguish between ascii text 62 and non-ascii data. Since the MIME is non-ascii, then when the non-ascii portion is reached in the scrolling, i.e. image 63, indicator 67 is turned on in scroll bar 61. Alternately, the various non-ascii files within a MIME may be recognized by their file extensions. Whether a non-ascii file is part of a MIME, as in FIG. 4, or alone, as in FIG. 3, the browser will read the file extension and thereby determine the file type. On the Web, files transmitted are identified by file extensions. For example: dolphins.bmp, dolphins.mov, dolphins.jpg or dolphins.gif, where the extensions define the file types. The above-mentioned text, Mastering the Internet, at pp. 300-313, discusses the various file extensions handled by Web browsers and the types and nature of the files they designate.

While the present invention is most advantageously used in identifying data types in Web documents and E-mail, it may be used in standalone document processing systems. For example, in a lengthy legal brief, changes made throughout the document may be entered in italics. Thus, the system of scrolling through the document for subsequent proofing and editing may be set up so that whenever the italics type of data is reached, the indicator appears in the scroll bar.

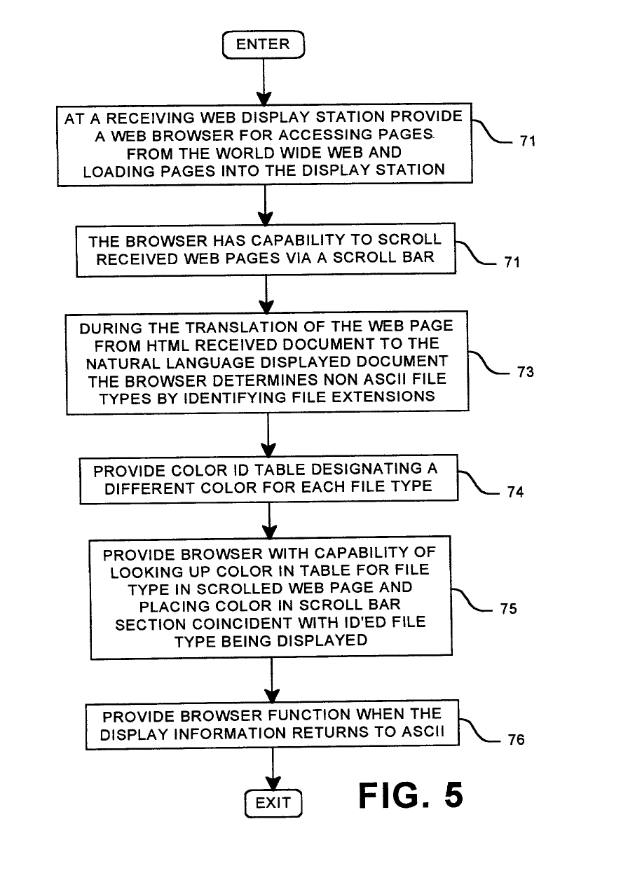

FIG. 5 is a flowchart showing the development of a process according to the present invention for providing a scroll bar indicator identifying selected types of data. The illustration will be at a Web receiving station where there is provided a Web browser for accessing pages from the Web and for loading and displaying such pages at a receiving display station, step 71. The browser is provided with the capability to scroll the received pages via a scroll bar, step 72. During the translation of the Web page from the received Web page in HTML to the natural language of the displayed document, the browser is provided with the capability of defining non-ascii file types by identifying their respective file extensions, step 73. A color ID Table is provided for designating a different color for each file type, step 74. The browser is provided with the capability of looking up the respective colors for the file types in the scrolled Web page and placing the looked up colors in the scroll bar sections coincident with the identified file type being currently displayed, step 75. The browser then returns to other normal browser functions when the scrolled data returns to the ascii type, step 76.

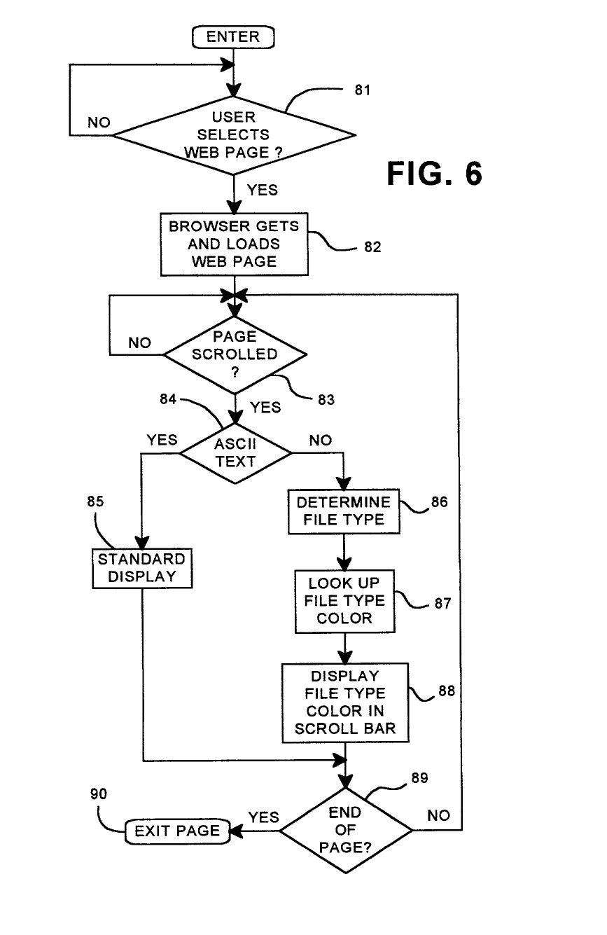

The running of the process set up in FIG. 5 will now be described with respect to the flowchart of FIG. 6. The flowchart represents some steps in a routine that will illustrate the operation of the invention as set forth in the above process. An initial determination is made, step 81, as to whether the user has requested a Web page. If No, the process is returned to step 81 and the selection of such a page is awaited. If Yes, then the browser obtains and loads the requested Web page. A determination is made as to whether the scrolling has commenced, step 83. If No, the process is returned to step 83 and the commencement of scrolling is awaited. If Yes, then a further determination is made as to whether the current data being scrolled past is ascii text, step 84. If Yes, it is routinely displayed, step 85. If No, then the file type is determined, step 86, the color of the determined file type is looked up, step 87, and the appropriate color is displayed in the scroll bar coincident with the file type being scrolled, step 88. At this point and/or after step 85, a determination is made as to whether we are at the end of the page being scrolled, step 89. If Yes, the particular page is exited, step 90. If No, the process is returned to step 83 where the scrolling is continued.

One of the preferred implementations of the present invention is in application program 40, i.e. a browser program made up of programming steps or instructions resident in RAM 14, FIG. 1, of a Web receiving station during various Web operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a computer controlled display, a system for scrolling a displayed document including different types of displayed data comprising:
means for scrolling the displayed document including a scroll bar;
means for determining the type of the displayed data being scrolled; and
means responsive to said determining means for indicating within said scroll bar the type of data being scrolled.

2. The system for scrolling in a computer controlled display of claim 1 wherein:
said means for scrolling the displayed document in a selected direction;
said scroll bar indicates the position of the displayed data in the direction being scrolled; and
said means for indicating the type of data being scrolled at said position.

3. The system for scrolling in a computer controlled display of claim 2 wherein said means for indicating the type of data being scrolled is a color indicator.

4. The system for scrolling of claim 2 wherein:
said computer controlled display is a receiving station on the World Wide Web (Web); and
said displayed document is a Web page.

5. The system for scrolling of claim 4 wherein said means for indicating the type of data being scrolled is a color indicator.

6. The system for scrolling of claim 4 wherein the type of displayed data being indicated is non-ascii text data.

7. The system for scrolling of claim 6 wherein said non-ascii text data are GIF files.

8. The system for scrolling of claim 7 wherein said non-ascii text data are MIME enclosures.

9. The system for scrolling of claim 5 wherein:
said Web page is a HTML page; and
the type of displayed data being indicated are embedded hyperlinks.

10. The Web system of claim 5 further comprising:
Web browsing means at said receiving display station comprising:
said means for determining the type of the displayed data being scrolled at said position; and
said means responsive to said determining means for indicating within said scroll bar the type of data being scrolled at said position.

11. A method for scrolling a displayed document including different types of displayed data in a computer controlled display comprising:
scrolling the displayed document with a scroll bar;
determining the type of the displayed data being scrolled; and
indicating within said scroll bar said determined type of data being scrolled.

12. The method for scrolling of claim 11 wherein:
said displayed document is scrolled in a selected direction;
said scroll bar indicates the position of the displayed data in the direction being scrolled; and
said the type of data indicated is the type of data at said position.

13. The method for scrolling of claim 12 wherein said type of data being scrolled is indicated in color.

14. The method for scrolling of claim 12 wherein:
said computer controlled display is a receiving station on the Web; and
said displayed document is a Web page.

15. The method for scrolling of claim 14 wherein said type of data being scrolled is indicated in color.

16. The method for scrolling of claim 15 wherein the type of displayed data being indicated is non-ascii text data.

17. The method for scrolling of claim 15 wherein said non-ascii text data are GIF files.

18. The method for scrolling of claim 15 wherein said non-ascii text data are MIME enclosures.

19. The method for scrolling of claim 15 wherein:
said Web pate is a HTML page; and
the type of displayed data being indicated are embedded hyperlinks.

20. The method of claim 15 further comprising:
a Web browsing process at said receiving display station comprising said steps of:
determining the type of displayed data being scrolled at said position; and
indicating within said scroll bar said determined type of data being scrolled at said position.

21. A computer program having code recorded on a computer readable medium for scrolling a displayed document including different types of displayed data in a computer controlled display comprising:
means for scrolling the displayed document including a scroll bar;
means for determining the type of the displayed data being scrolled; and
means responsive to said determining means for indicating within said scroll bar the type of data being scrolled.

22. The computer program of claim 21 wherein:
said means for scrolling the displayed document in a selected direction;
said scroll bar indicates the position of the displayed data in the direction being scrolled; and
said means for indicating the type of data being scrolled at said position.

23. The computer program of claim 22 wherein said means for indicating the type of data being scrolled is a color indicator.

24. The computer program of claim 22 wherein:
said computer controlled display is a receiving station on the Web; and
said displayed document is a Web page.

25. The computer program of claim 24 wherein said means for indicating the type of data being scrolled is a color indicator.

26. The computer program of claim 25 wherein the type of displayed data being indicated is non-ascii text data.

27. The computer program of claim 26 wherein said non-ascii text data are GIF files.

28. The computer program of claim 26 wherein said non-ascii text data are MIME enclosures.

29. The computer program of claim 25 wherein:
said Web page is a HTML page; and
the type of displayed data being indicated are embedded hyperlinks.

30. The computer program of claim 25 further comprising:
a Web browser program at said receiving display station comprising:
said means for determining the type of the displayed data being scrolled at said position; and
said means responsive to said determining means for indicating within said scroll bar the type of data being scrolled at said position.
